(19) United States
(12) Patent Application Publication
(10) Pub. No.: US 2011/0233223 A1
(43) Pub. Date: Sep. 29, 2011

(54) CUP SLEEVE

(76) Inventors: Matthew R. Cook, Hinsdale, IL (US); Kurt M. Wolf, Chicago, IL (US); Thomas Fu, Naperville, IL (US)

(21) Appl. No.: 12/748,020

(22) Filed: Mar. 26, 2010

(51) Int. Cl. B65D 25/36; B31D 99/00

(52) U.S. Cl. 220/738; 220/903; 493/287; 493/310; 229/403

(57) ABSTRACT

A cup sleeve includes a planar sheet of material that defines a first support member, a second support member, a third support member, a fourth support member, a first ledge member, and a second ledge member. The first support member is adjacent to the first ledge member and the second ledge member. The second support member is positioned substantially opposite to the first support member and is adjacent to the first ledge member and the second ledge member. The first support member and the second support member are configured to rotate to follow an outer contour of a cup when the cup is inserted into a center region of the sleeve in a direction that is normal to a plane defined by the sleeve in an unassembled configuration. The first ledge member and the second ledge member are configured to stay in substantially the same plane as the plane defined by the unassembled sleeve when the cup is inserted into the center region of the sleeve.

### FIELD

The present application relates to a sleeve for a cup that insulates a user's hand from heat produced in the cup.

### DESCRIPTION OF RELATED ART

Cup sleeves are utilized to provide protection from heat produced by a hot liquid in a cup. A typical cup sleeve comprises a sheet of material in which opposing ends are attached together. The opposing ends may be glued or otherwise fastened to each other. To provide for compactness, the sheet may be pressed into a generally flat configuration. To utilize the cup sleeve, a user pinches the opposing ends of the flattened sleeve towards each other. This causes the flattened sheets to separate from one another and form an opening for receiving the cup. Once separated, the user inserts the cup into the opening.

### BRIEF SUMMARY

A cup sleeve includes a planar sheet of material that defines a first support member, a second support member, a third support member, a fourth support member, a first ledge member, and a second ledge member. The first support member is adjacent to the first ledge member and the second ledge member. The second support member is positioned substantially opposite to the first support member and is adjacent to the first ledge member and the second ledge member. The first support member and the second support member are configured to rotate to follow an outer contour of a cup when the cup is inserted into a center region of the planar sheet of material in a direction that is normal to the planar sheet of material. The first ledge member and the second ledge member are configured to stay in substantially the same plane as the planar sheet of material when the cup is inserted into the center region of the sheet of material.

Other systems, methods, features and advantages of the invention will be, or will become, apparent to one with skill in the art upon examination of the following figures and detailed description. It is intended that all such additional systems, methods, features and advantages be included within this description, be within the scope of the claims, and be protected by the following claims.

### BRIEF DESCRIPTION OF THE DRAWINGS

The accompanying drawings are included to provide a further understanding of the claims, are incorporated in, and constitute a part of this specification. The detailed description and illustrated embodiments described of the invention serve to explain the principles defined by the claims.

FIG. 1 illustrates a perspective view of a cup inserted into a cup sleeve;

FIGS. 2-5 illustrate first-fourth side views of the cup and sleeve of FIG. 1;

FIG. 6 illustrates a top view of the cup and sleeve of FIG. 1;

FIG. 7 illustrates a bottom view of the cup and sleeve of FIG. 1;

FIG. 8 illustrates a top view of an exemplary sleeve in an unassembled configuration that may correspond to the sleeve of FIG. 1;

FIG. 9 illustrates a top view of a second exemplary sleeve in an unassembled configuration; and

FIGS. 10-13 illustrate top views of third, fourth, fifth, and sixth exemplary sleeves in an unassembled configuration.

### DETAILED DESCRIPTION OF THE DRAWINGS

The exemplary embodiments below describe various embodiments of cup sleeves that comprise a single sheet of material that may be cut and folded in various locations to enable a cup to be inserted into the sleeves. The sleeves are in the form of a planar sheet of material in an unassembled configuration. When a cup is inserted into the sleeve, various support members of the sleeve rotate, thus allowing the cup to be inserted into the sleeve. The sleeve also includes various ledge members that stay in the same plane as the sleeve in the unassembled configuration when the cup is inserted into the sleeve.

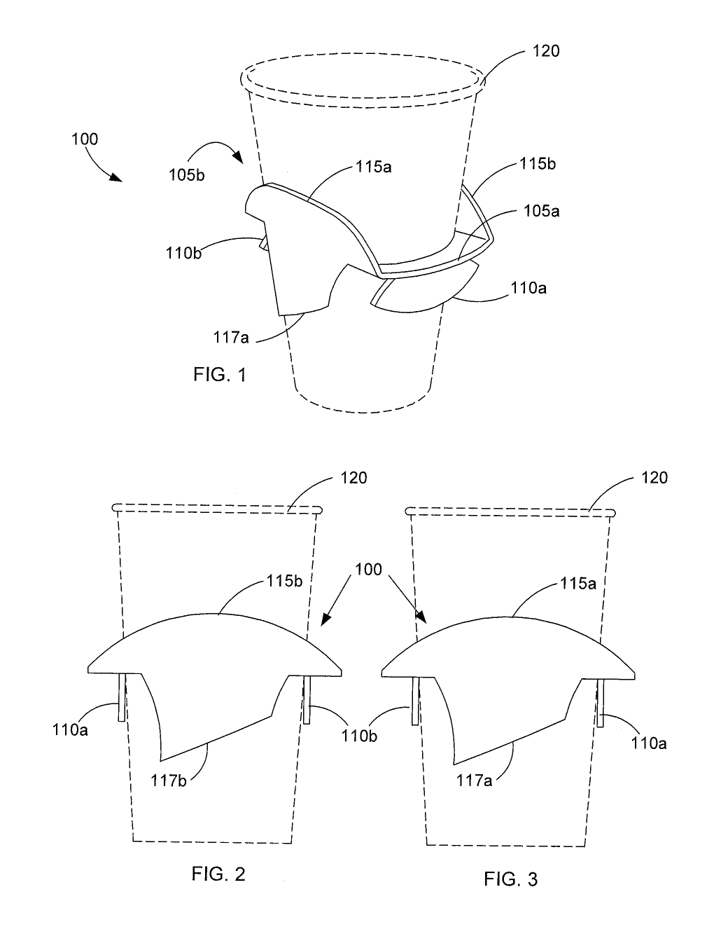

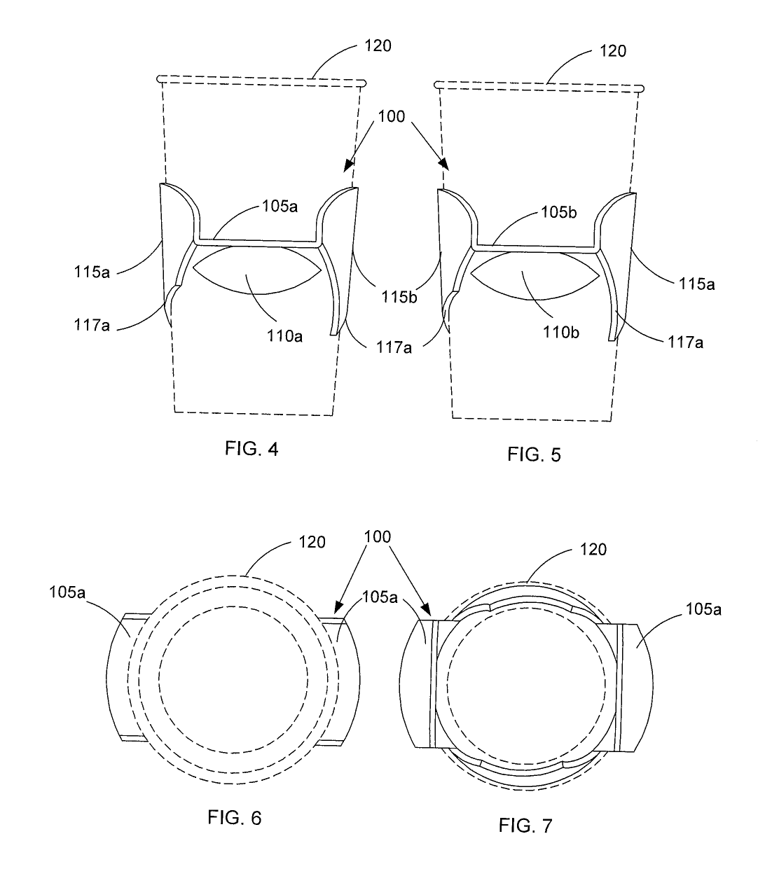

FIGS. 1-7 illustrate a perspective view and various side views of a cup 120 inserted into a cup sleeve 100. The cup sleeve 100 is hereinafter referred to as the sleeve 100. The sleeve 100 is made of a single sheet of material that defines a first support member 115a, a second support member 115b, a first ledge member 105a, and a second ledge member 105b. The sheet of material may be made of an insulating material capable of protecting a user from heat generated within the cup 120. For example, the sheet of material may comprise a corrugated paper material.

As shown in FIG. 1, the first support member 115a is positioned adjacent to the first ledge member 105a and the second ledge member 105b. The second support member 115b is positioned substantially opposite to the first support member 115a and is positioned adjacent to the first ledge member 105a and the second ledge member 105b.

The first support member 115a and the second support member 115b generally follow the outer contour of the cup 120 and provide an insulating surface to protect the user from heat generated within the cup 120. In some implementations, the first support member 115a and the second support member 115b define a diagonal bottom edge 117a and 117b. The shape of the bottom edges 117a and 117b may be different. For example, the bottom edges 117a and 117b may be straight, have an S-curve shape, or a different shape. The shape of the bottom edges 117a and 117b may be identical or different.

The first ledge member 105a and the second ledge member 105b extend away from the cup 120 in a plane that is generally normal to the surface of the cup 120. The first ledge member 105a and the second ledge member 105 enhance a user's ability to hold the cup 120 by providing a support platform for holding the cup. For example, the user may place his thumb under the first ledge member 105a and his index finger under the second ledge member 105b. The respective ledges 105a and 105b allow the user to holder the cup without having to squeeze the cup. This reduces fatigue on the user's hand.

In some implementations, the sleeve 100 also includes a third support member 110a extending from the first ledge member 105a and a fourth support member 110b extending from the second ledge member 105b. The third support member 110a and the fourth support member 110b insulate the user's thumb and index finger from heat produced within the cup 120.

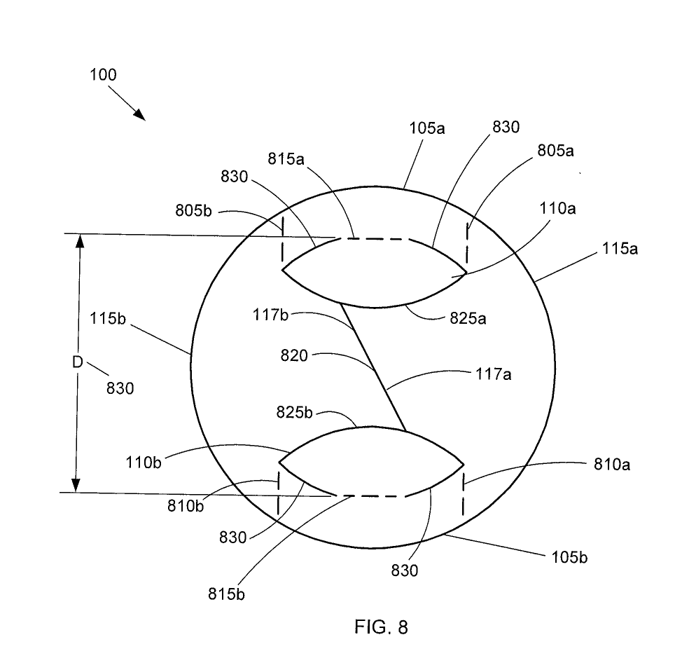

FIG. 8 illustrates a top view of an exemplary sleeve 100 in an unassembled configuration that may correspond to the sleeve 100 shown in FIGS. 1-7. The dashed segments correspond to regions about which the sleeve 100 is folded. Solid segments correspond to cuts in the sleeve 100 that serve to separate and define the various elements of the sleeve 100. In the unassembled configuration, the sleeve 100 is a generally planar sheet of material and may have a circular shape. The sleeve 100 defines a first support member 115a, a second support member 115b, a third support member 110a, a fourth support member 110b, a first ledge member 105a, and a second ledge member 105b.

The first support member 115a is adjacent to the first ledge member 105a and the second ledge member 105b. The second support member 115b is positioned substantially opposite to the first support member 115a and is adjacent to the first ledge member 105a and the second ledge member 105b.

The first ledge member 105a shares a first foldable edge 805a with the first support member 115a and a second foldable edge 805b with the second support member 115b. The second ledge member 105b shares a first foldable edge 810a with the first support member 115a and a second foldable edge 810b with the second support member 115b. The shape of the respective foldable edges may be straight.

The third support member 110a shares a foldable edge 815a with the first ledge member 105a and the fourth support member 110b shares a foldable edge 815b with the second ledge member 105b. The shape of the respective foldable edges may be straight.

The sleeve 100 defines a first cut 820, a second cut 825a, and a third cut 825b. The first cut 820 separates and defines the lower edge 117a of the first support member 115a and the lower edge 117b of the second support member 115b. The second cut 825a separates the first support member 115a and the second support member 115b from the first ledge member 105a and the third support member 110a, and defines the shape of the lower edge of the third support member 110a. The third cut 825b separates the first support member 115a and the second support member 115b from the second ledge member 105b and the fourth support member 110b, and defines the lower edge of the fourth support member 110b. The first cut 820 may be diagonally shaped and is utilized to separate the first support member 115a and the second support member 115b to form complementary diagonally shaped lower edges 117a and 117b on the first support member 115a and the second support member 115b, respectively.

The sleeve 100 also defines a group of cuts 830 that enable the third support member 110a and the fourth support member 110b to rotate independently of the first ledge member 105a and the second ledge member 105b, respectively. The group of cuts 830 may correspond to arc segments of a circle centered at the center of the sleeve 100 with a diameter D 830 that serves to limit the amount by which a cup 120 may be inserted into the sleeve 100. For example, the cup 120 may be tapered and the diameter of the cup 120 in the center of the cup 120 may equal D 830. In this case, the cup 120 may be inserted into the sleeve 100 until the sleeve 100 is positioned at the center of the cup 120, at which point resistance between the sleeve 100 and the cup 120 prevents the cup 120 from being inserted any further.

In operation, a cup 120 is inserted into the center of the sleeve 100 in a direction that is normal to the sleeve 100. Upon insertion, the first support member 115a, second support member 115b, third support member 110a, and fourth support member 110b begin to rotate along respective foldable edges 805a, 805b, 810a, 810b, 815a, and 815b to follow the outer contour of the cup 120. During insertion, the first ledge member 105a and the second ledge member 105b are configured to stay in substantially the same plane defined by the sleeve 100 when it is in the unassembled configuration. Insertion continues until resistance is encountered between the cup and the foldable edge 815a that is shared between the third support member 110a and the first ledge member 105a, and the foldable edge 815b that is shared between the fourth support member 110b and the second ledge member 105b.

In some implementations, a user inserts the cup into the sleeve 100 manually. For example, the user may hold the sleeve 100 along the first ledge member 105a and the second ledge member 105b and then insert the cup 120 into the center region of the sleeve 100.

In other implementations, a dispensing apparatus (not shown) is provided. The dispensing apparatus may include a tray that stores one or more sleeves 100 in the unassembled configuration of FIG. 8. The dispensing apparatus may be configured to retrieve a sleeve 100 from the tray and to position the sleeve 100 below a cup 120. The dispensing apparatus may include a handling mechanism (not shown) operative to secure the sleeve by the first ledge member 105a and the second ledge member 105b. The handling mechanism may be configured to enable the first support member 115a, the second support member 115b, the third support member 110a, and the fourth support member 110b to freely rotate when the cup 120 is inserted into the sleeve 100. Afterwards, the cup 120 and sleeve 100 are removed from the handling mechanism. For example, a user may simply remove the cup and sleeve from the handling mechanism. Alternatively, the handling mechanism may position the cup 120 and sleeve 100 below a beverage dispensing apparatus operative to dispense a liquid into the cup 120. Once filled, the cup 120 and sleeve 100 may be released.

At least one advantage of the sleeve 100 is that no glue or other attaching means are required to form the various elements of the sleeve 100. This reduces the number of manufacturing steps needed to produce the sleeve 100 and, therefore, reduces the overall cost of the sleeve 100.

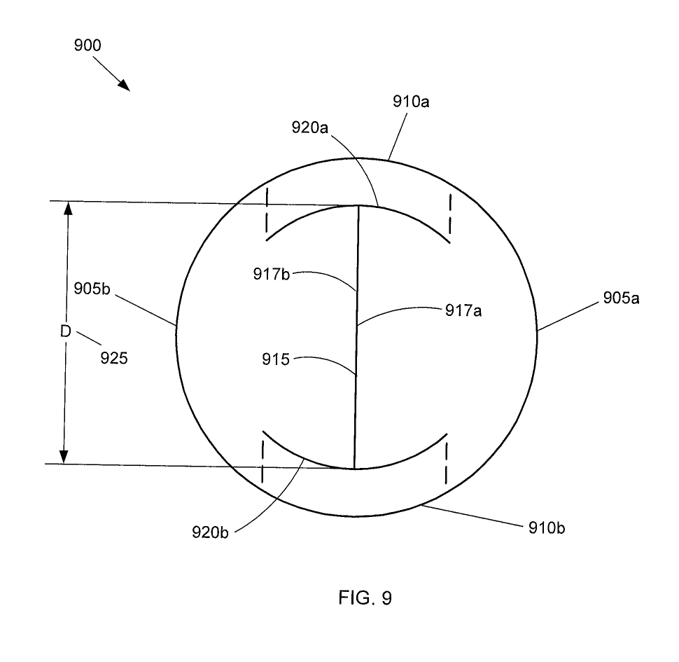

FIG. 9 illustrates a top view of a second exemplary sleeve 900 in an unassembled configuration. The sleeve 900 is a generally planar sheet of material that includes all the features of the exemplary sleeve 100 of FIG. 8 except for the third support member 110a and the fourth support member 110b.

As shown, the first support member 905a is adjacent to the first ledge member 910a and the second ledge member 910b. The second support member 905b is positioned substantially opposite to the first support member 905a and is adjacent to the first ledge member 910a and the second ledge member 910b.

A straight cut 915 separates the first support member 905a from the second support member 905b and defines the lower edges 917a and 917b of the first support member 905a and the second support member 905b, respectively. A second cut 920a separates the first support member 905a and the second support member 905b from the first ledge member 910a. A third cut 920b separates the first support member 905a and the second support member 905b from the second ledge 910b.

The first cut 915 may define a straight line. The second cut 920a and the third cut 920b may correspond to arc segments of a circle centered at the center of the sleeve 900 with a diameter D 925. The diameter D 925 serves to limit the amount by which a cup may be inserted into the sleeve 900, as described above.

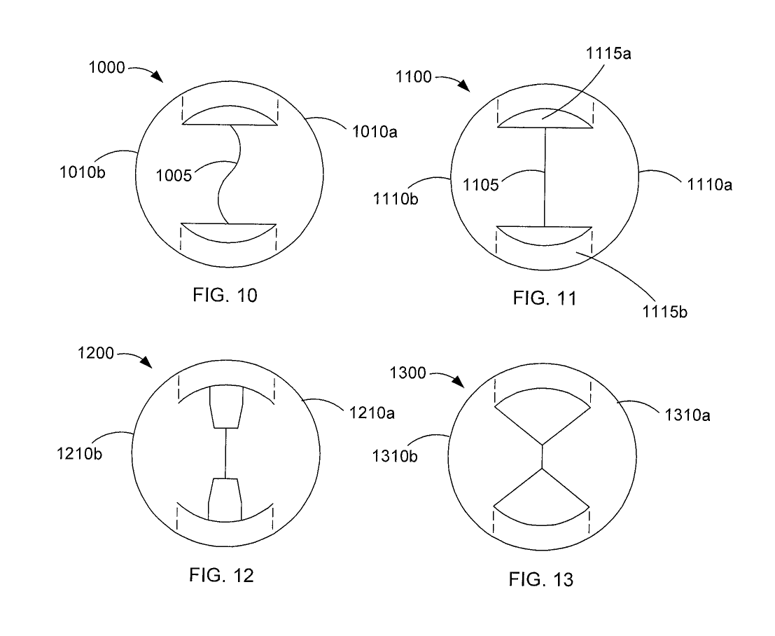

While various embodiments have been described, it will be apparent to those of ordinary skill in the art that many more embodiments and implementations are possible that are within the scope of the claims. For example, the shapes of the respective elements of the sleeves may be changed by changing the shape of the cuts that separate the various elements, as illustrated in FIGS. 10-13. For example, as shown in FIG. 10, a first cut 1005 may be in the shape of an S-curve to form an S-curve lower edge on a first support member 1010a and a second support member 1010b. As shown in FIG. 11, a first support member 1110a and second support member 1110b may be separated by a straight cut 1105 to form a straight lower edge. The sleeve 1100 may also define a third support member 1115a and a fourth support member 1115b. As shown in FIGS. 12 and 13, the third support member 1210a and 1310a and the fourth support member 1210b and 1310b may have a different shape. Other shapes may be defined. Therefore, the embodiments described are only provided to aid in understanding the claims and do not limit the scope of the claims.

1. A cup sleeve comprising:
a planar sheet of material that defines a first support member and a second support member and a first ledge member and a second ledge member, wherein the first support member is adjacent to the first ledge member and the second ledge member and the second support member is positioned substantially opposite to the first support member and is adjacent to the first ledge member and the second ledge members, and wherein the first support member and the second support member are configured to rotate to follow an outer contour of a cup when the cup is inserted into a center region of the planar sheet of material in a direction that is normal to the planar sheet of material, and the first ledge member and the second ledge member are configured to stay in substantially a same plane as the planar sheet of material when the cup is inserted into the center region of the planar sheet of material.

2. The cup sleeve according to claim 1, wherein the first ledge member shares a first foldable edge with the first support member and a second foldable edge with the second support member, and the second ledge member shares a first foldable edge with the first support member and a second foldable edge with the second support member.

3. The cup sleeve according to claim 1, further comprising a third support member that shares a foldable edge with the first ledge member and a fourth support member that shares a foldable edge with the second ledge member, wherein the third support member and the fourth support member are configured to rotate so as to follow an outer contour of a cup when the cup is inserted into the center region of the planar sheet of material in a direction that is normal to the planar sheet of material.

4. The cup sleeve according to claim 1, further comprising a cut in the planar sheet that separates the first support member and the second support member.

5. The cup sleeve according to claim 4, wherein the cut is a diagonal cut.

6. The cup sleeve according to claim 4, wherein the cut has an S-curve shape.

7. The cup sleeve according to claim 1, wherein the planar sheet of material comprises a corrugated paper material.

8. The cup sleeve according to claim 1, wherein the planar sheet of material is circular.

9. A method of manufacturing a cup sleeve comprising:
providing a planar sheet of material;
cutting the planar sheet of material to define a first support member and a second support member and a first ledge member and a second ledge member, wherein the first support member is adjacent to the first ledge member and the second ledge member and the second support member is positioned substantially opposite to the first support member and is adjacent to the first ledge member and the second ledge members, and wherein the first support member and the second support member are configured to rotate to follow an outer contour of a cup when the cup is inserted into a center region of the planar sheet of material in a direction that is normal to the planar sheet of material, and the first ledge member and the second ledge member are configured stay in substantially a same plane as the planar sheet of material when the cup is inserted into the center region of the planar sheet of material.

10. The method according to claim 9, wherein the first ledge member shares a first foldable edge with the first support member and a second foldable edge with the second support member, and the second ledge member shares a first foldable edge with the first support member and a second foldable edge with the second support member.

11. The method according to claim 9, further comprising cutting the planar sheet of material to define a third support member that shares a foldable edge with the first ledge member and a fourth support member that shares a foldable edge with the second ledge member, wherein the third support member and the fourth support member are configured to rotate to follow an outer contour of a cup when the cup is inserted into the center region of the sheet of material in a direction that is normal to the planar sheet of material.

12. The method according to claim 9, further comprising cutting the planar sheet of material to separate the first support member and the second support member.

13. The method according to claim 12, wherein a cut that separates the first support member and the second support member is a diagonal cut.

14. The method according to claim 12, wherein a cut that separates the first support member and the second support member has an S-curve shape.

15. The method according to claim 9, wherein the planar sheet of material comprises a corrugated paper material.

16. The method according to claim 9, where the planar sheet of material is circular.
